(19) United States
(12) Patent Application Publication
(10) Pub. No.: US 2018/0056609 A1
(43) Pub. Date: Mar. 1, 2018

(54) METHOD FOR PRODUCING A COMPOSITE TUBE FOR A MOTOR VEHICLE BODY AND ALSO COMPOSITE TUBE AND MOTOR VEHICLE

(71) Applicant: Ford Global Technologies, LLC, Dearborn, MI (US)

(72) Inventors: Igor Licko, Piestany (SK); Selahattin Türel Memili, Duisburg (DE)

(73) Assignee: Ford Global Technologies, LLC, Dearborn, MI (US)

(21) Appl. No.: 15/685,366

(22) Filed: Aug. 24, 2017

(30) Foreign Application Priority Data
Aug. 25, 2016 (DE) 102016216028.1

(51) Int. Cl. B29C 70/30; B29C 70/06; B62D 29/00; B62D 25/06; B29D 23/00

(52) U.S. Cl. CPC B29C 70/305; B29C 70/06; B62D 29/001; B29L 2023/00; B29D 23/00; B29C 2791/002; B62D 25/06

(57) ABSTRACT

The present disclosure provides a composite tube and a method for producing a composite tube for a vehicle body. The method includes the steps of: providing a metal tube; forming the tube into a prespecified shape; introducing a spray gun into the tube; and spraying on a fiber coating in at least one region of the inner side of the tube using the spray gun. The fiber coating is a matrix material with embedded fibers. The method further includes removing the spray gun from the tube, and hardening the fiber coating. The present disclosure also provides a motor vehicle having a vehicle body which includes a composite tube.

### CROSS-REFERENCE TO RELATED APPLICATIONS

This application claims priority to and the benefit of DE 102016216028.1 filed on Aug. 25, 2016. The disclosure of the above application is incorporated herein by reference.

### FIELD

The present disclosure relates to a composite tube and a method for producing a composite tube for a vehicle body.

### BACKGROUND

The statements in this section merely provide background information related to the present disclosure and may not constitute prior art.

Tubes in which different materials are used constitute composite tubes. Such composite tubes can for example be advantageously used in the field of automobiles because in order to provide a robust body structure of a motor vehicle the correct materials have to be used at the correct points. In lightweight construction, particularly material mixes are also used in this case. Furthermore, hydroformed tubes are used for example in the sidewall structure of the vehicle body. In this case, it concerns tubes which are produced by means of internal high pressure forming (IHF). In this case, metal tubes or hollow bodies are formed in a mold by means of internal pressure. This technique can be used for A-columns right up to C/D columns.

On account of increasing safety requirements, in the case of vehicles with such tubes in the sidewall structure there is the risk, however, that they do not pass a rollover test since they have a less rigid and less robust structure. Therefore, an improvement of tube technology in this field is desired. Safety can for example be increased by the use of tailor rolled tubes.

There are also attempts in other fields for an improvement of the properties of tubes, wherein in particular reinforcing has been pursued by means of fiber-reinforced plastic. CN 103775754 A describes for example tubes for use as oil pipelines which have an inner coating consisting of carbon fibers, and a method for producing such tubes. In this case, the inner carbon fiber coating consists of a component A and a component B. The component A contains 50-100 kg of carbon fiber powder, 30-70 kg of silicon carbide, 65-150 kg of aluminum oxide and 20-50 kg of zirconium oxide. The component B contains 100-240 kg of adhesive and 100-240 kg of accelerator.

CN 204437507 U in comparison describes tubes for water pipelines consisting of fiber-reinforced plastic. The tubes comprise a coating of fiber-reinforced plastic, wherein the outer side of this coating is provided with a polyurethane layer. This polyurethane layer is provided from the inside outward sequentially with a layer of carbon fiber fabric mesh and glass fibers.

It is also known from DE 10 2014 004 158 A1 to produce structural elements by a load application element being introduced into a fiber-plastic composite hollow profile. The fiber-plastic composite hollow profile which is used is a hollow profile, reinforced by endless fibers and endlessly produced, with a thermoplastic matrix. In this case, the load application element which is to be introduced has an undercut and is introduced into the fiber-plastic composite hollow profile. The fiber-plastic composite hollow profile is then locally heated in order to form it in the region of the undercut of the load application element. The fiber-plastic composite hollow profile is then laid in a mold and sprayed with free-flowing injection molding material in order to form an undercut of the fiber-plastic composite hollow profile which is joined to the undercut of the load application element in a precisely fitting manner.

WO 01/072495 A1 describes a composite component and a method for its production. The composite component consists of a hollow profile basic body and a plastic element which is fixedly connected to the hollow profile basic body. The plastic element is sprayed onto the hollow profile basic body in this case, wherein the connection between the two elements is carried out at discrete connection points by the hollow profile basic body being encased at these connection points partially or wholly with the injected plastic of the plastic element. The composite component can be used in the field of automobiles, especially as a front-end module, tailgate, door function module, or seat component.

These known composite profiles, however, are only of limited suitability for use inside a vehicle body. On the evidence of the demonstrated prior art, the field of tubes for vehicle bodies therefore offers more room for improvements.

### SUMMARY

The present disclosure provides a lightweight composite tube for a vehicle body by means of which the safety requirements for the vehicle body can be met.

According to the present disclosure, a method for producing a composite tube having the features of claim 1 is provided. The present disclosure is also achieved by means of an associated composite tube as claimed and by means of a motor vehicle having such a composite tube as claimed. The respectively dependent sub-claims disclose further, particularly advantageous forms of the present disclosure.

A method according to the present disclosure for producing a composite tube for a vehicle body comprises the steps of:

providing a tube of metal;

forming the tube into a prespecified shape;

introducing a spray gun into the tube;

spraying on a fiber coating in at least one region of the inner side of the tube using the spray gun, wherein the fiber coating is a matrix material with embedded fibers;

removing the spray gun from the tube; and

hardening the fiber coating.

In this way, a metal composite tube with an internal reinforcing coating of carbon fibers, aramid fibers and glass fibers can be produced, wherein the fibers which are named by way example are naturally not intended to be limiting. As used herein, carbon fibers should be construed to mean any fiber materials, which can bring about suitable reinforcement. In this case, the fiber coating, that is to say the carbon fiber coating, is applied locally in one region, i.e. the entire inner surface of the tube is not provided with the carbon fiber coating. However, a multiplicity of local reinforcement areas can also be provided.

Therefore, the present disclosure provides a method with which tubes having rolled sheet metal plate with improved characteristics can be produced. In this case, in one region of the inner side of a tube thin carbon fibers are sprayed on so that the tube is reinforced in this region. Using this method, however, any coating thicknesses are possible. In one form, the coating thicknesses for the carbon fiber coating are in the order of magnitude of 1 mm to 5 mm. The regions which are to be reinforced especially result from the crash requirements which are imposed upon the vehicle when using the composite tube in the body of a vehicle. In this case, the coatings can also be applied in sections so that specific reinforcement patterns result. These reinforcement patterns can be of ring-like, truss-like or waffle-like form.

The tubes of rolled sheet metal plate, before spraying on the carbon fiber coating, can be brought into a prespecified shape by means of hydroforming. It may also concern tubes the sheet metal plates of which have been tailored before connecting and welding. Such sheet metal plates are also referred to as “tailored blanks.” If such tubes have regions in which a reinforcement is desired, they can be locally reinforced using the method according to the present disclosure. In this way, increased safety requirements can also be met with such tubes, which for example is desired when using the tubes in the sidewall region of a vehicle body. The reinforcement of the tube structures leads to increased rigidity in the process. In particular, the crash behavior during a rollover test can thereby be improved.

In this case, the spraying on of carbon fibers constitutes a process which can be carried out in a particularly cost effective manner. The tubes can also be produced beforehand using already existing methods which do not have to be adapted for the method according to the present disclosure. This is also an advantage of the method according to the present disclosure.

In one form of the present disclosure, the tube has at least one cross-sectional enlargement, and the carbon fiber coating is sprayed on in the region of this cross-sectional enlargement. Therefore, the tube can be reinforced in this region. A plurality of such reinforcement regions can also be provided in the composite tube.

The tube which is to be reinforced can be formed from steel or aluminum. Especially when using aluminum, a large weight reduction can be realized as a result of the material matrix of aluminum and carbon fibers. This is advantageous for the lightweight construction of motor vehicles. Lightweight construction is environmentally friendly since it contributes to a reduction of CO₂.

If the tube is formed from aluminum, the hardening of the carbon fiber coating can take place within a process for the artificial ageing of the aluminum. The hardening of the carbon fiber coating can also take place within a process for the baking of a lacquer coating on a motor vehicle. In this way, no separate hardening process has to be provided, but the hardening can be carried out in processes which take place anyway on a motor vehicle. Also, this contributes to the method according to the present disclosure being able to be carried out very cost effectively. Used in this case as matrix material can be for example plastomers or a resin, such as epoxy resin, into which the carbon fibers are mixed. However, metal powders or hot-sprayed metals also come into question as matrix material.

The tube which is used can have a constant or variable wall thickness. It typically has a constant wall thickness when it has been produced from sheet metal plate using conventional methods. For example, the tube can be brought into a prespecified shape by means of simple hydroforming. However, it can also be adapted in tailored form to specific requirements (tailored tube), wherein a sheet metal plate is first of all adapted to these requirements and then formed into a tube. This subsequent forming can also be carried out by means of hydroforming. The present disclosure is suited to the use of both types of tubes.

Also covered by the present disclosure is a composite tube for a vehicle body in which a tube is made of metal, on the inner side of which a carbon fiber coating is applied in at least one region. In this case, the composite tube is produced by means of one form of the method according to the present disclosure so that the previously mentioned advantages also apply to the resulting composite tube. Such a composite tube can be of lightweight design but still with an adequate degree of rigidity. It is simple to construct in the process. Furthermore, the carbon fibers on the inside offer the advantages that the composite tube can easily be connected to other components using conventional methods. In this respect, it may concern welded connections or riveted connections, for example.

Also covered by the present disclosure is a motor vehicle having a vehicle body in which at least one composite tube is included according to the present disclosure. The composite tube can especially be included in a side door structure or roof structure of the vehicle body. In one form of the present disclosure, the composite tube is for example a roof strut which connects an A-column to a C-column or to a D-column of the motor vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a longitudinal section through a tube for use in a method according to the teachings of the present disclosure;

FIG. 2 shows an introduction of a spray gun into the tube according to FIG. 1;

FIG. 3 shows a beginning of a spraying on of a carbon fiber coating on an inner side of the tube according to FIG. 1;

FIG. 4 shows continuing spraying on a carbon fiber coating;

FIG. 5 shows an end of spraying on of a carbon fiber coating;

FIG. 6 shows a longitudinal section through a tube after removing a spray gun;

FIG. 7 shows a first perspective view of a composite tube; and

FIG. 8 shows a second perspective view of the composite tube according to FIG. 7.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

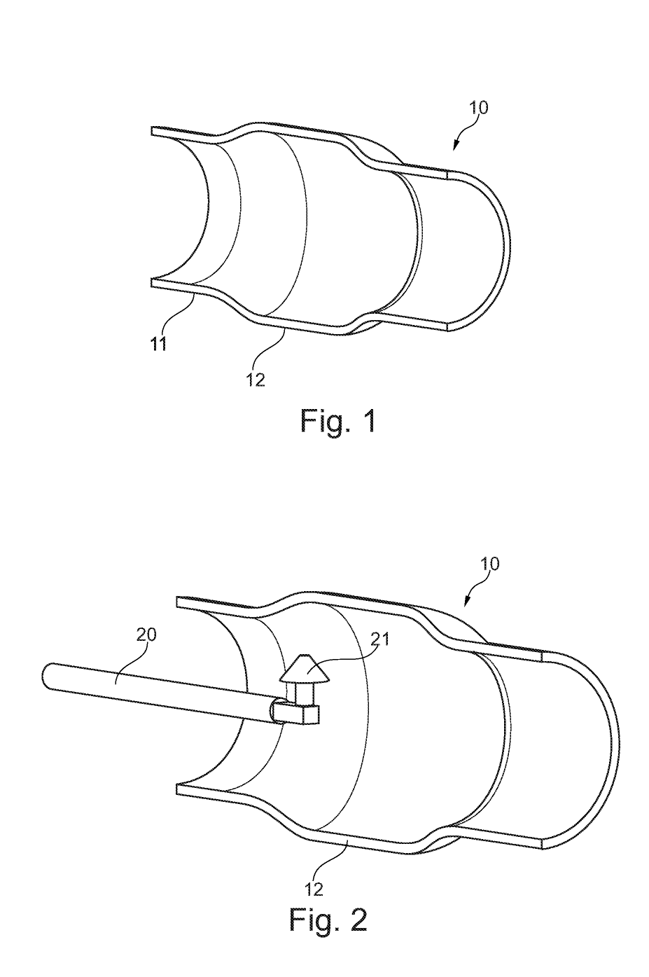

A method according to the present disclosure provides a tube 10 produced from a metal, in which the tube in at least one region is to be reinforced with fibers, that is to say with carbon fibers, for example. For the tube, steel or aluminum can be used. By way of example, FIG. 1 shows a longitudinal section through such a tube 10. In this case, the shape and the dimensions of the tube 10 are only by way of example and serve for explanation of the present disclosure. The tube 10 can therefore also have other shapes.

The tube 10 according to FIG. 1 can for example be a tube which on a side structure or roof structure, such as a roof strut, of a motor vehicle connects an A-column to a C-column or to a D-column. It has a tube wall 11 which in one region has a cross-sectional enlargement 12. In this region, the inside diameter of the tube 10 is enlarged, wherein such a cross-sectional enlargement can also be provided at other places of the tube 10.

This shape, or a different shape, of a tube can be created for example by means of hydroforming. In this case, a tube with initially constant cross section is introduced into a closed mold and by applying an internal pressure is brought into a prespecified shape. The wall thickness of the tube 10 can in this case be constant or variable over its length.

A specially designed spray gun 20 is introduced into the interior of this tube 10, as is to be gathered from FIG. 2. This spray gun 20 is dimensioned so that its nozzle 21 can be brought into a defined position inside the tube 10. In this case, the spray gun 20 has one or more nozzles, wherein for simplification only one nozzle 21 is shown in the figures. This nozzle 21 is directed toward the inner surface of the tube 10, wherein it points upward, for example.

Using the spray gun 20, a mixture of matrix material and fibers, e.g. carbon fibers, can then be sprayed onto a region of the inner surface of the tube 10. As a result, a continuous fiber coating 30, that is to say a carbon fiber coating 30, for example, is created, wherein as matrix material a resin such as epoxy resin for example can be used. In one form, the continuous spraying on is carried out by the tube 10 being rotated around its longitudinal axis and by an axial movement of the tube 10 relative to the spray gun 20 taking place. Alternatively, the tube 10 can also be stationary and the spray gun 20 rotated and moved in the axial direction through the tube 10. Also possible are mixed shapes in which for example the tube 10 is rotated and the spray gun 20 is moved axially through the tube 10 (or vice versa) at the same time.

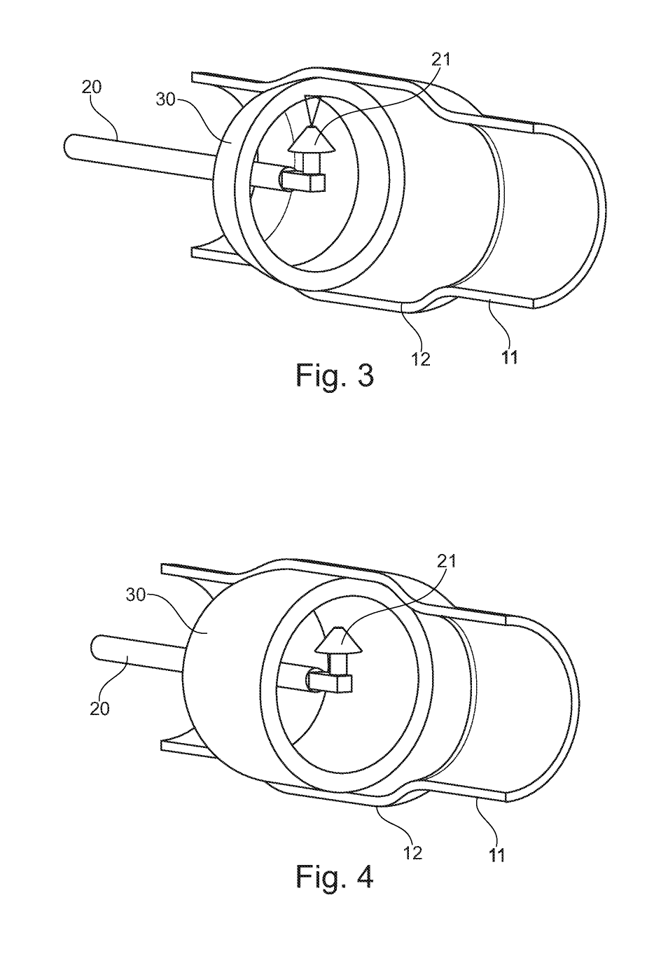

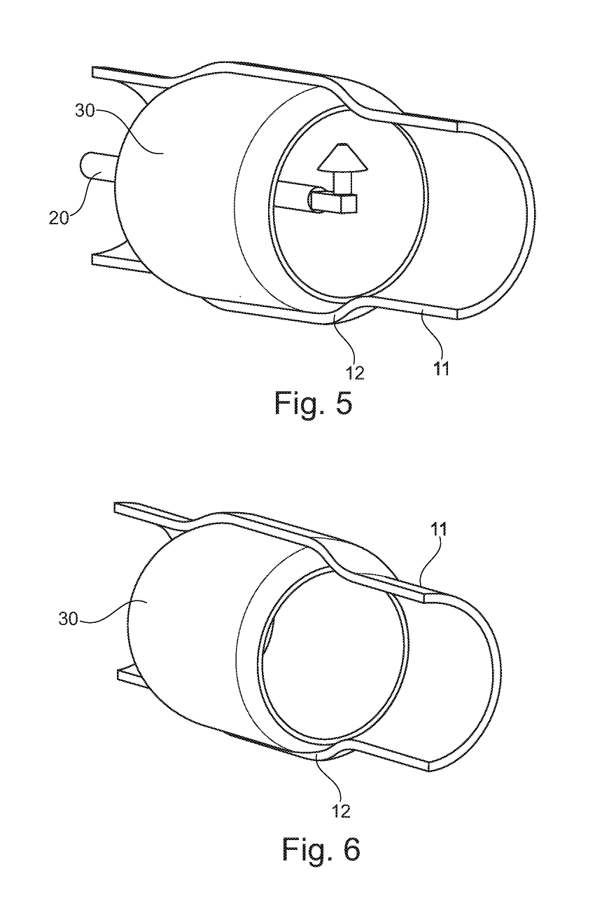

In this way, the inner surface of the tube 10 can be sprayed continuously with fibers, e.g. with carbon fibers, wherein in the selected exemplary form only the region of the cross-sectional enlargement 12 is sprayed with fiber-reinforced plastic, e.g. with carbon fiber-reinforced plastic. FIG. 3 shows in this case the beginning of the spraying on process, FIG. 4 shows a point in time in the middle and FIG. 5 shows the end of the spraying on process. At the end, the region of the cross-sectional enlargement 12 is provided completely with a fiber coating 30, e.g. with a carbon fiber coating 30. The spray gun 20 can then be removed from the pipe. This situation is shown in FIG. 6.

The figures show in this case the fiber coating 30, e.g. the carbon fiber coating 30, in the still longitudinally sectioned tube 10. The tube 10 which is thereby provided with a carbon fiber coating 30 is subjected to a hardening process in an oven by supplying heat so that the fiber coating 30, that is to say for example the carbon fiber coating 30, is hardened. As a result of this, the composite tube which is to be produced is formed.

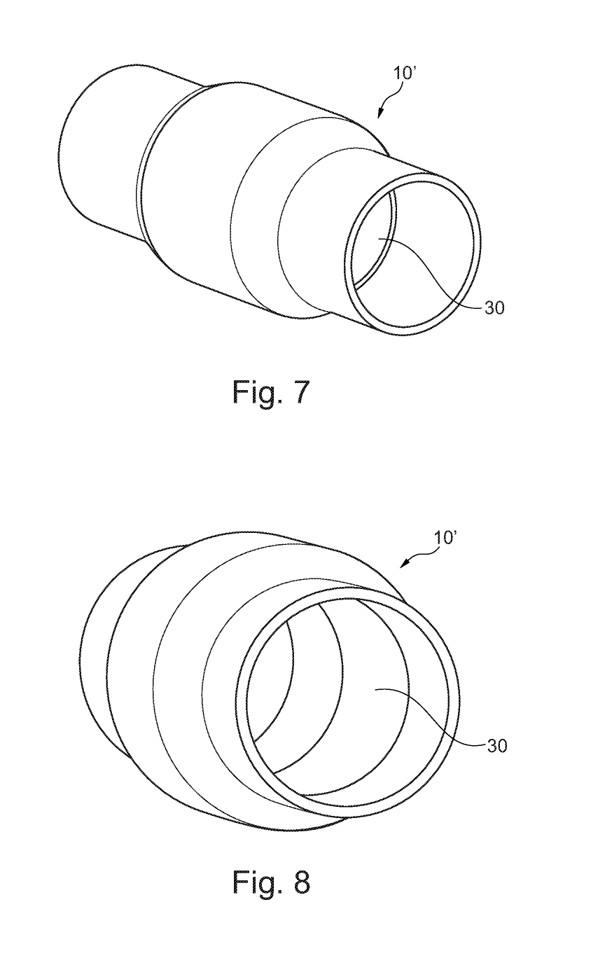

FIG. 7 shows the entire tube in a first perspective view, wherein it is now a composite tube 10′ with a carbon fiber coating on the inside for reinforcement. FIG. 8 shows this composite tube 10′ in a second perspective view.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing a composite tube for a vehicle body, the method comprising:
providing a metal tube;
forming the tube into a prespecified shape;
introducing a spray gun into the tube;
spraying a fiber coating in at least one region of an inner side of the tube using the spray gun, wherein the fiber coating is a matrix material with embedded fibers;
removing the spray gun from the tube; and
hardening the fiber coating.

2. The method according to claim 1, wherein the tube is formed from steel or aluminum.

3. The method according to claim 1, wherein the tube has at least one cross-sectional enlargement, and the fiber coating is sprayed on a region of the cross-sectional enlargement.

4. The method according to claim 3, wherein the fiber coating is only sprayed on the at least one cross-sectional enlargement of the tube.

5. The method according to claim 1, wherein the tube is formed from aluminum, and the hardening of the fiber coating takes place within a process for an artificial aging of the aluminum.

6. The method according to claim 1, wherein the hardening of the fiber coating takes place within a process for baking of a lacquer coating on a motor vehicle.

7. The method according to claim 1, wherein the tube is formed into the prespecified shape by hydroforming.

8. A composite tube for a vehicle body, the composite tube produced according to the method of claim 1.

9. The composite tube according to claim 8, wherein the fiber coating is applied in sections in a form of a reinforcement pattern.

10. The composite tube according to claim 9, wherein the reinforcement pattern is selected from the group consisting of ring-like, truss-like, and waffle-like forms.

11. A motor vehicle having a vehicle body that includes at least one composite tube according to claim 8.

12. The motor vehicle according to claim 11, wherein the composite tube is included in at least one of a side structure or a roof structure of the vehicle body.

13. The motor vehicle according to claim 11, wherein the composite tube is a roof strut which connects an A-column to a C-column or to a D-column.

14. The method according to claim 1, wherein the embedded fibers are carbon fibers.

15. The method according to claim 1, wherein the matrix material includes at least one of a resin or plastomers.

16. The method according to claim 1, wherein walls of the tube have a constant thickness along a length of the tube.

17. The method according to claim 1, wherein the spray gun includes at least one nozzle that is directed toward an inner surface of the tube.

18. The method according to claim 1, wherein spraying the fiber coating comprises the steps of continuously spraying the fiber coating while rotating the tube around a longitudinal axis and simultaneously moving the tube in an axial direction relative to the stationary spray gun.

19. The method according to claim 1, wherein spraying the fiber coating comprises the steps of continuously spraying the fiber coating while rotating the spray gun and simultaneously moving the spray gun in an axial direction through the stationary tube.

20. The method according to claim 1, wherein spraying the fiber coating comprises the steps of continuously spraying the fiber coating while rotating the tube around a longitudinal axis and simultaneously moving the spray gun in an axial direction through the tube.
